(19) United States
(12) Patent Application Publication
(10) Pub. No.: US 2009/0073284 A1
(43) Pub. Date: Mar. 19, 2009

(54) IMAGING APPARATUS AND METHOD

(76) Inventors: Kenzo ISOGAWA, Kanagawa-ken (JP); Nao Mishima, Tokyo (JP); Goh Itoh, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/209,059

(22) Filed: Sep. 11, 2008

(30) Foreign Application Priority Data
Sep. 19, 2007 (JP) P2007-242707

(51) Int. Cl. H04N 5/76; H04N 5/335

(52) U.S. Cl. 348/231.99; 348/294; 348/E05.091; 348/E05.031

(57) ABSTRACT

An image sensor has a plurality of photo detectors each having a spectral sensitivity. An image data input unit inputs image data having a position, a spectral sensitivity, and a measured signal value of each photo detector in an area of the image sensor. A parameter estimation unit estimates each parameter of a plurality of spectral intensity functions using the image data. Each spectral intensity function represents an intensity of light corresponding to a spectrum in the area. An intensity estimation unit estimates the intensity of light in the area using the plurality of spectral intensity functions with each parameter. An output unit outputs the intensity of light for each photo detector.

### CROSS-REFERENCE TO RELATED APPLICATIONS

This application is based upon and claims the benefit of priority from prior Japanese Patent Application No. 2007-242707, filed on Sep. 19, 2007; the entire contents of which are incorporated herein by reference.

### FIELD OF THE INVENTION

The present invention relates to an imaging apparatus and method for outputting multi-primary colors by a single-chip image sensor having a color filter.

### BACKGROUND OF THE INVENTION

In order to realize a small-sized camera, a color filter array is installed onto the camera. With regard to the color filter array, color filters having a plurality of spectral transmissions are arranged on a single-chip image sensor. A color image is acquired from image data captured by the single-chip image sensor.

With regard to the color filter, a Bayer array comprising R, G, and B color filters, or a complementary filter comprising C_{y}, M_{g}, Yₑ, and G color filter, i.e., a color filter for three-primary colors is often used.

Furthermore, the demosaicking method for capturing a color image from output of each color filter is proposed. For example, the ACPI method (disclosed in the following patent reference 1) is proposed for the Bayer array.

In order to improve accuracy of color reproduction, display of multi-primary colors (equal to or larger than four colors) different from above-mentioned three-primary colors is also proposed. For example, an imaging system of multi-primary colors is disclosed in the following non-patent reference 1. However, it is problem that a large-sized apparatus is necessary.

Furthermore, as disclosed in the following patent reference 2, two kinds of G filters are prepared in order to improve accuracy of color reproduction. However, this method is specialized for the display of three-primary colors, and not applied to the display of multi-primary colors.

Furthermore, by changing the color filter, technique to obtain effect except for improvement of accuracy of color reproduction is proposed. For example, in the following patent reference 3, a dynamic range can be extended.

However, this method is basically specialized for the display of three-primary colors, and individually specialized for the color filter. Accordingly, in case of changing the color filter or the number of colors to be output, another demosaicking method for exclusive use is necessary.

[Patent reference 1] JP No. 3510037

[Patent reference 2] JP-A (Kokai) No. 2003-284084

[Patent reference 3] JP-A (Kokai) No. 2003-199117

[Non-patent reference 1] M. Yamaguchi, T. Teraji, K. Ohsawa, T. Uchiyama, H. motomura, Y. Murakami, and N. Ohyama, “Color image reproduction based on the multispectral and multiprimary imaging: Experimental evaluation”, Proc. SPIE, vol. 4663 (2002) 15-26

[Non-patent reference 2] H. Takeda, S. Farsiu, and P. Milanfar, “Kernel Regression for Image Processing and Reconstruction”, Trans. on IP, vol. 16, pp. 349-366, 2007

### SUMMARY OF THE INVENTION

The present invention is directed to an imaging apparatus and method for outputting multi-primary colors by using a single-chip image sensor to which an arbitrary color filter is installed.

According to an aspect of the present invention, there is provided an apparatus for capturing an image, comprising: an image sensor having a plurality of photo detectors, each photo detector having a spectral sensitivity; an image data input unit configured to input image data having a position, a spectral sensitivity, and a measured signal value of each photo detector in an area of the image sensor; a parameter estimation unit configured to estimate each parameter of a plurality of spectral intensity functions using the image data, each spectral intensity function representing an intensity of light corresponding to a spectrum in the area; an intensity estimation unit configured to estimate the intensity of light in the area using the plurality of spectral intensity functions with each parameter; and an output unit configured to output the intensity of light for each photo detector.

According to another aspect of the present invention, there is also provided a method for capturing an image by an image sensor having a plurality of photo detectors, each photo detector having a spectral sensitivity, comprising: inputting image data having a position, a spectral sensitivity, and a measured signal value of each photo detector in an area of the image sensor; estimating each parameter of a plurality of spectral intensity functions using the image data, each spectral intensity function representing an intensity of light corresponding to a spectrum in the area; estimating the intensity of light in the area using the plurality of spectral intensity functions with each parameter; and outputting the intensity of light for each photo detector.

According to still another aspect of the present invention, there is also provided a computer readable medium storing program codes for causing a computer to capture an image by an image sensor having a plurality of photo detectors, each photo detector having a spectral sensitivity, the program codes comprising: a first program code to input image data having a position, a spectral sensitivity, and a measured signal value of each photo detector in an area of the image sensor; a second program code to estimate each parameter of a plurality of spectral intensity functions using the image data, each spectral intensity function representing an intensity of light corresponding to a spectrum in the area; a third program code to estimate the intensity of light in the area using the plurality of spectral intensity functions with each parameter; and a fourth program code to output the intensity of light for each photo detector.

### BRIEF DESCRIPTION OF THE DRAWINGS

FIG. 1 is a block diagram of the imaging apparatus according to a first embodiment.

FIG. 2 is a flow chart of processing of the imaging apparatus in FIG. 1.

FIG. 3 is a schematic diagram of a block of 5×5 pixels extracted from WRGB array centering around B photo detector.

FIG. 4 is a graph showing a spectral sensitivity of each photo detector in an image sensor used in the first embodiment.

FIG. 5 is a schematic diagram of an image sensor having photo detector array different from a squire grid.

FIG. 6 is a block diagram of the imaging apparatus according to a second embodiment.

FIG. 7 is a flow chart of processing of the imaging apparatus in FIG. 6.

FIGS. 8A, 8B and 8C are schematic diagrams showing concept of positional weight.

FIG. 9 is a schematic diagram showing change of light intensity on a minute area.

FIG. 10 is a schematic diagram of a block of 5×5 pixels which the block of FIG. 3 is shifted one line along the right direction.

FIG. 11 is a block diagram of the imaging apparatus according to a third embodiment.

FIG. 12 is a flow chart of processing of the imaging apparatus in FIG. 11.

FIGS. 13A, 13B, 13C, and 13D are schematic diagrams showing type of the color filter array in the block of FIG. 3.

FIG. 14 is a graph showing four spectral transmissions.

### DETAILED DESCRIPTION OF THE EMBODIMENTS

Hereinafter, various embodiments of the present disclosure will be explained by referring to the drawings. The present invention is not limited to the following embodiments.

(Concept of the Imaging Apparatus 100)

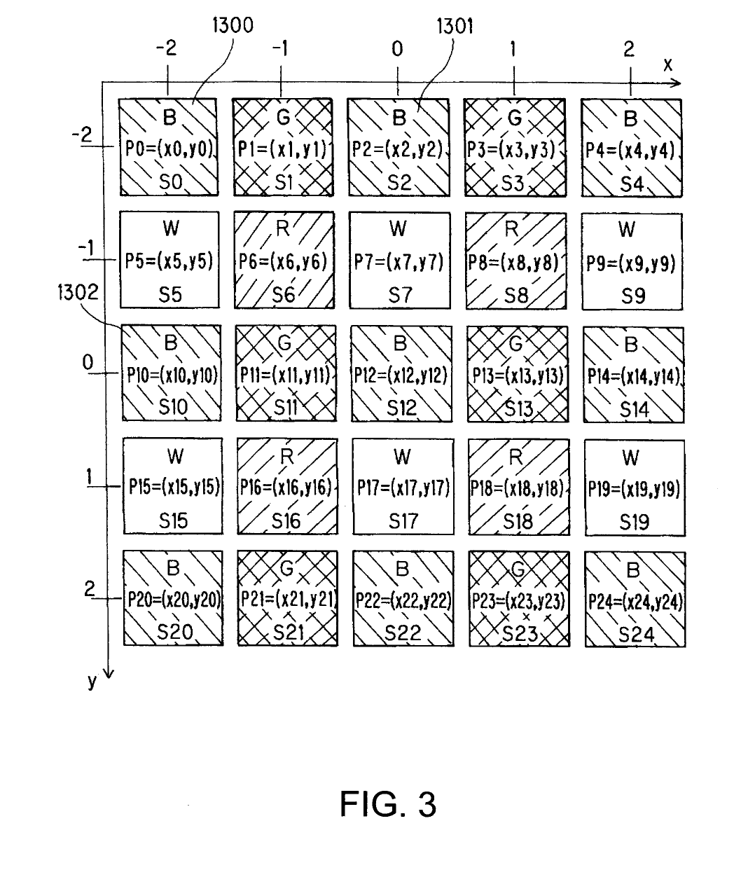

Concept of an imaging apparatus 100 is explained by referring to FIGS. 3, 4, and 14.

(1) Purpose of the Imaging Apparatus 100:

For example, the imaging apparatus 100 is used for capturing image data for a multi-primary colors display which outputs an image with multi-primary colors (larger than three-primary colors “R,G,B”).

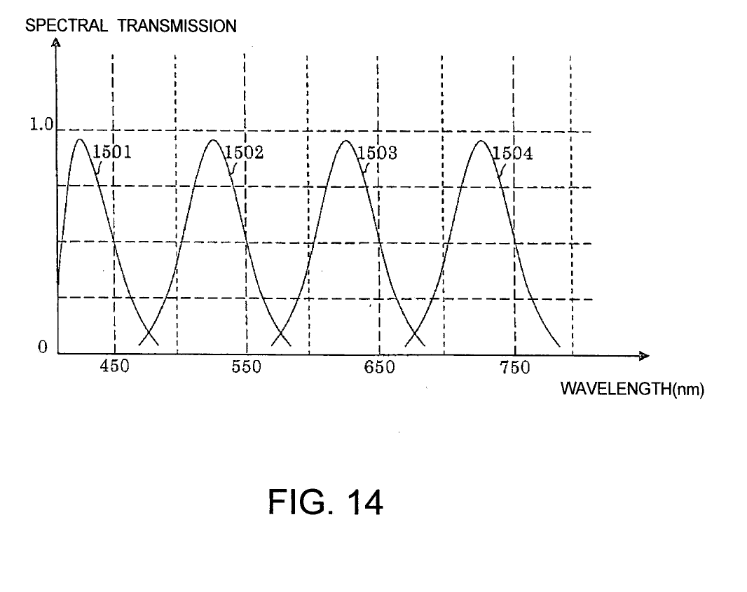

For example, a multi-primary colors display outputs an image with four colors corresponding to spectra 1501˜1504 (Hereafter, each spectrum is called “a, b, c, d”) in FIG. 14. In case that the imaging apparatus 100 is connected to the multi-primary colors display, the imaging apparatus 100 can output signals corresponding to four spectra a˜d.

In this case, output of the imaging apparatus 100 does not necessarily coincide with spectral transmissions of color filter of the display. By transforming the output in a color space at post stage, if the output coincides with the spectral transmissions of color filter of the display, any output from the imaging apparatus 100 may be used.

(2) Summary of the Imaging Apparatus 100:

At the position of each pixel on the image sensor, the imaging apparatus 100 estimates intensities of light whose spectrums (colors) are different each other. To estimate the intensities, the imaging apparatus 100 uses a group of pixel in the neighborhood of the pixel, called a block.

FIG. 3 is a schematic diagram of a block composed of 5×5 pixels, on a single-chip image sensor. The single-chip image sensor has four kinds of photo detectors each having different spectral sensitivity (R photo detector having R color filter, G photo detector having G color filter, B photo detector having B color filter, W photo detector without color filter). Hereinafter, processing is explained by referring to FIG. 3 as one example.

First, “a spectral intensity function”, “a spectral weight”, and “a model error E” (each necessary for explanation of the embodiments) are explained.

(3) Spectral Intensity Function:

The spectral intensity function is a function model representing change of light intensity in a block. In the first embodiment, in order to represent change of light intensity in one block, a plurality of spectral intensity functions is defined. The maximum number of spectral intensity functions is equal to the number of kinds of colors (color filters). Furthermore, a different spectral transmission corresponds to each spectral intensity function.

Hereinafter, each spectral intensity function is defined as four functions fₐ(x,y), f_{b}(x,y), f_{c}(x,y) and f_{d}(x,y) corresponding to four spectra a, b, c and d in FIG. 14. In this case, “(x,y)” is two-dimensional coordinate to represent a position in the block, and a center of the block is the origin of the coordinate system.

For example, the spectral intensity function is represented as follows.

$$( \begin{matrix}{f}_{a} ( x , y ) \\ {f}_{b} ( x , y ) \\ {f}_{c} ( x , y ) \\ {f}_{d} ( x , y )\end{matrix} ) = ( \begin{matrix}1 & 0 & 0 & 0 & x & y & {x}^{2} & xy & {y}^{2} \\ 0 & 1 & 0 & 0 & x & y & {x}^{2} & xy & {y}^{2} \\ 0 & 0 & 1 & 0 & x & y & {x}^{2} & xy & {y}^{2} \\ 0 & 0 & 0 & 1 & x & y & {x}^{2} & xy & {y}^{2}\end{matrix} ) ( \begin{matrix}{β}_{a} \\ {β}_{b} \\ {β}_{c} \\ {β}_{d} \\ {β}_{1} \\ {β}_{2} \\ {β}_{3} \\ {β}_{4} \\ {β}_{5}\end{matrix} ) \qquad ( 1 )$$

If the equation (1) correctly represents change of light intensity in the block, quality of output image is improved. The light intensity changes and the spectral intensity function may cope with various changes of the light intensity. With regard to a form of “fₐ(x,y)” in the equation (1), an arbitrary function is expanded (Maclaurin's expansion) and approximated using first and second terms. In other word, the form corresponds to a large number of functions. Accordingly, by increasing the number of terms with Maclaurin's expansion, a complicated form (various change of light intensity) can be represented as the spectral intensity function. However, in case of increasing the number of terms, parameters of spectral intensity functions, estimated by spectral intensity function estimation unit 102, are more sensitive to noise. In other words, the image obtained from the imaging apparatus 100 becomes noisy. The number of terms may be controlled by a user.

At the same time, a form of the spectral intensity function should be controlled, to suppress the false color. In ACPI method, the false color is suppressed by keeping the difference between RGB signal constant in the block. For the same purpose, in the first embodiment, derived functions of at least two or all the spectral intensity functions are set to be identical. A form of the spectral intensity function except for the parameters is arbitrarily determined by a user, and previously stored.

(4) Spectral Weight:

Next, the spectral weight is explained. In the first embodiment, a curved line showing a spectral sensitivity of each photo detector (WRGB) is represented by a spectral weight (positive real number). The spectral weight is larger when the overlap between the spectral sensitivity of photo detector and the spectrum related to the spectral intensity function is large.

The spectral weight is notated as c[B,a] using a sign of color filter (any of W, R, G, B) and a sign of spectral transmission (any of a, b, c, d), i.e., corresponding spectral intensity function.

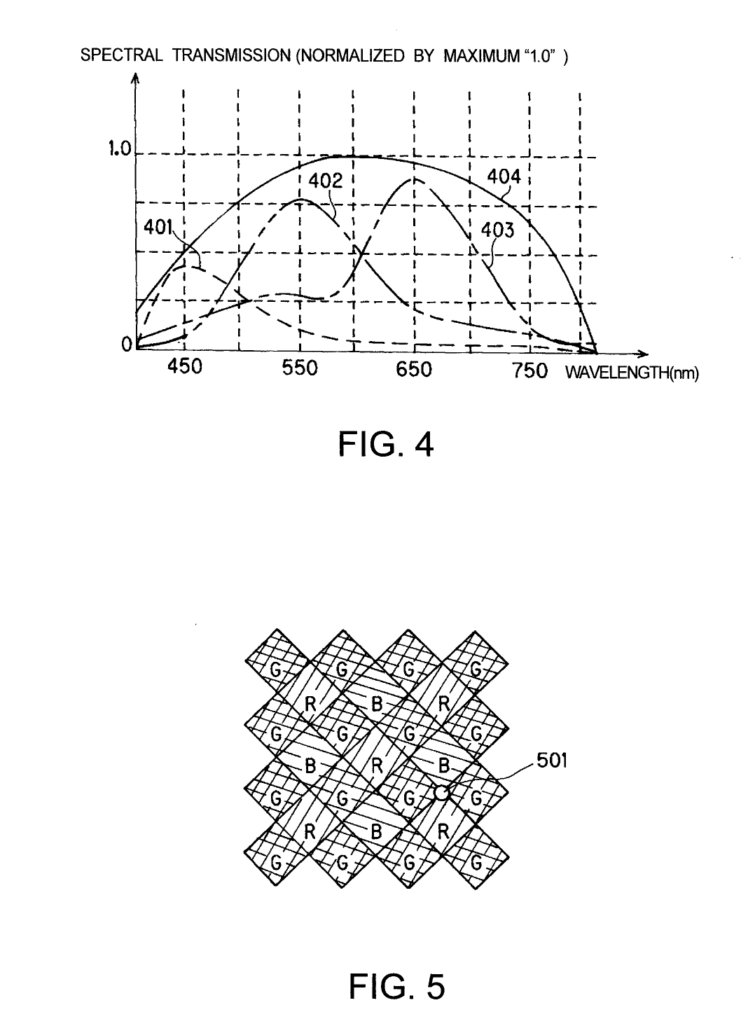

In a graph of FIG. 4, a vertical axis represents a spectral transmission, and a horizontal axis represents a wavelength. The vertical axis is normalized with the maximum “1.0”. In FIG. 4, a spectral sensitivity of B photo detector is shown as a curved line 401, a spectral sensitivity of G photo detector is shown as a curved line 402, a spectral sensitivity of R photo detector is shown as a curved line 403, a spectral sensitivity of W photo detector is shown as a curved line 404. For example, the spectral weight is represented as follows.

$$\begin{matrix}{C}_{cf} = ( \begin{matrix}c [ R , a ] & c [ R , b ] & c [ R , c ] & c [ R , d ] \\ c [ G , a ] & c [ G , b ] & c [ G , c ] & c [ G , d ] \\ c [ B , a ] & c [ B , b ] & c [ B , c ] & c [ B , d ] \\ c [ W , a ] & c [ W , b ] & c [ W , c ] & c [ W , d ]\end{matrix} ) \\ = ( \begin{matrix}0.1 & 0.26 & 0.85 & 0.1 \\ 0.1 & 0.76 & 0.23 & 0.2 \\ 0.5 & 0.1 & 0.01 & 0.01 \\ 0.5 & 0.95 & 0.95 & 0.7\end{matrix} )\end{matrix} \qquad ( 2 )$$

In a matrix of the equation (2), each element is a larger value when a spectral sensitivity (FIG. 4) of each color filter more overlaps with a spectral transmission (corresponding to the spectral intensity function). The number of colors to be output has the upper limit as a rank of matrix C_{cf} in the equation (2). The spectral weight is defined for each spectral intensity function.

(5) Model Error:

Last, a model error E is explained. In the first embodiment, as a numerical scale whether a model of light intensity (by the spectral intensity function) in the block correctly represents actual measured data, the model error E (positive real number) is used.

First, a model signal value I′[x,y] (weighted sum of the spectral intensity function with the spectral weight) is represented as follows.

$${I}^{′} [ x , y ] = {\sum }_{p = \{ a , b , c , d \}} c [ {f}_{cf} ( x , y ) , p ] {f}_{p} ( x , y ) \qquad ( 3 )$$

The model error E is set to be smaller when an absolute value of difference between the model signal value I′[x,y] and a measured signal value s[x,y] (from the photo detector) is smaller.

In the equation (3), “f_{cf}(x,y)” represents a color filter at a position (x,y). For example, in the block shown in FIG. 3, f_{cf}(0,0)=B. The model error E is represented as follows.

$$E = {\sum }_{i = 0}^{24} {( s [ {x}_{i} , {y}_{i} ] - {I}^{′} [ {x}_{i} , {y}_{i} ] )}^{2} \qquad ( 4 )$$

The model error E of the equation (4) is transformed as follows.

$$\begin{matrix} E = {\vert S - W β \vert}^{2} & ( 5 ) \\ S = {( \begin{matrix}s [ {x}_{0} , {y}_{0} ] & s [ {x}_{1} , {y}_{1} ] & … & s [ {x}_{5} , {y}_{5} ] & s [ {x}_{6} , {y}_{6} ] & … & s [ {x}_{24} , {y}_{24} ]\end{matrix} )}^{T} \\ W = ( \begin{matrix}c [ B , a ] & c [ B , b ] & c [ B , c ] & c [ B , d ] & c [ B ] {x}_{0} & c [ B ] {y}_{0} & c [ B ] {x}_{0}^{2} & c [ B ] {x}_{0} {y}_{0} & c [ B ] {y}_{0}^{2} \\ c [ G , a ] & c [ G , b ] & c [ G , c ] & c [ G , d ] & c [ G ] {x}_{1} & c [ G ] {y}_{1} & c [ G ] {x}_{1}^{2} & c [ G ] {x}_{1} {y}_{1} & c [ G ] {y}_{1}^{2} \\ ⋮ & ⋮ & ⋮ & ⋮ & ⋮ & ⋮ & ⋮ & ⋮ & ⋮ \\ c [ R , a ] & c [ R , b ] & c [ R , c ] & c [ R , d ] & c [ R ] {x}_{5} & c [ R ] {y}_{5} & c [ R ] {x}_{5}^{2} & c [ R ] {x}_{5} {y}_{5} & c [ R ] {y}_{5}^{2} \\ c [ W , a ] & c [ W , b ] & c [ W , c ] & c [ W , d ] & c [ W ] {x}_{6} & c [ W ] {y}_{6} & c [ W ] {x}_{6}^{2} & c [ W ] {x}_{6} {y}_{6} & c [ W ] {y}_{6}^{2} \\ ⋮ & ⋮ & ⋮ & ⋮ & ⋮ & ⋮ & ⋮ & ⋮ & ⋮ \\ c [ B , a ] & c [ B , b ] & c [ B , c ] & c [ B , d ] & c [ B ] {x}_{24} & c [ B ] {y}_{24} & c [ B ] {x}_{24}^{2} & c [ B ] {x}_{24} {y}_{24} & c [ B ] {y}_{24}^{2}\end{matrix} ) \\ β = {( \begin{matrix}{β}_{a} & {β}_{b} & {β}_{c} & {β}_{d} & {β}_{1} & {β}_{2} & {β}_{3} & {β}_{4} & {β}_{5}\end{matrix} )}^{T} \\ c [ B ] = c [ B , a ] + c [ B , b ] + c [ B , c ] + c [ B , d ] \\ c [ G ] = c [ G , a ] + c [ G , b ] + c [ G , c ] + c [ G , d ] \\ c [ R ] = c [ R , a ] + c [ R , b ] + c [ R , c ] + c [ R , d ] \\ c [ W ] = c [ W , a ] + c [ W , b ] + c [ W , c ] + c [ W , d ] & ( 6 )\end{matrix}$$

As a method for calculating a vector β to minimize the model error E, an update algorithm such as the steepest-descent method or the conjugated gradient method can be used. Furthermore, by using a pseudo-inverse matrix (W⁺=(W^{t} W)⁻¹ W^{t}) of S and W, the vector β is calculated as follows.

β=W⁺S (7)

Briefly, W⁺ is a filter to calculate a parameter of the spectral intensity function. Forms of the spectral intensity function and the model error E may be determined by a user. However, a method for effectively calculating a parameter of the spectral intensity function to minimize the model error E is desired.

For example, in order to use the steepest-descent method and the conjugated gradient method, the spectral intensity function is necessary to be represented as a weighted sum of the basis function (function of position coordinate) with the parameter. For example, with regard to four spectral intensity functions in the equation (1), basis functions “1”, “x”, “y”, “x²”, “xy”, “y²” are multiplied with each parameter βₐ˜β₅, and added (weighted sum).

Furthermore, a total number of parameters of the spectral intensity function is necessary to be smaller than a total number of photo detectors in the block. For example, in case of the “5×5” block shown in FIG. 3, the number of photo detectors in the block is twenty five. Accordingly, the number of parameters of the spectral intensity function is set to be smaller than twenty five.

(6) Summary:

As mentioned-above, at the position of every photo detectors in the block, if the model signal values are similar to the signals detected by the photo detector, the spectral intensity function may describe the intensity of light in the block well.

In the imaging apparatus 100 of the first embodiment, the model error, which is larger when an absolute value of difference between the model signal value and the measured signal value is larger, is defined, and the spectral intensity function to minimize the model error is determined. By using the spectral intensity function, an intensity of light at arbitrary position in the block is estimated, and an output image is suitably generated.

Same definition of the spectral intensity functions, spectral weight, and model error can be used for another color filter arrays. In other words, the imaging apparatus 100 can contain an image sensor using various color filters. Accordingly, special imaging system is not necessary. In case of using a single-chip image sensor, by changing the spectral weight based on a color filter, the color filter may be feely changed. Furthermore, in case of increasing the number of colors to output based on the display of multi-primary colors, by increasing the number of spectral intensity functions, the number of colors may be freely increased.

### The First Embodiment

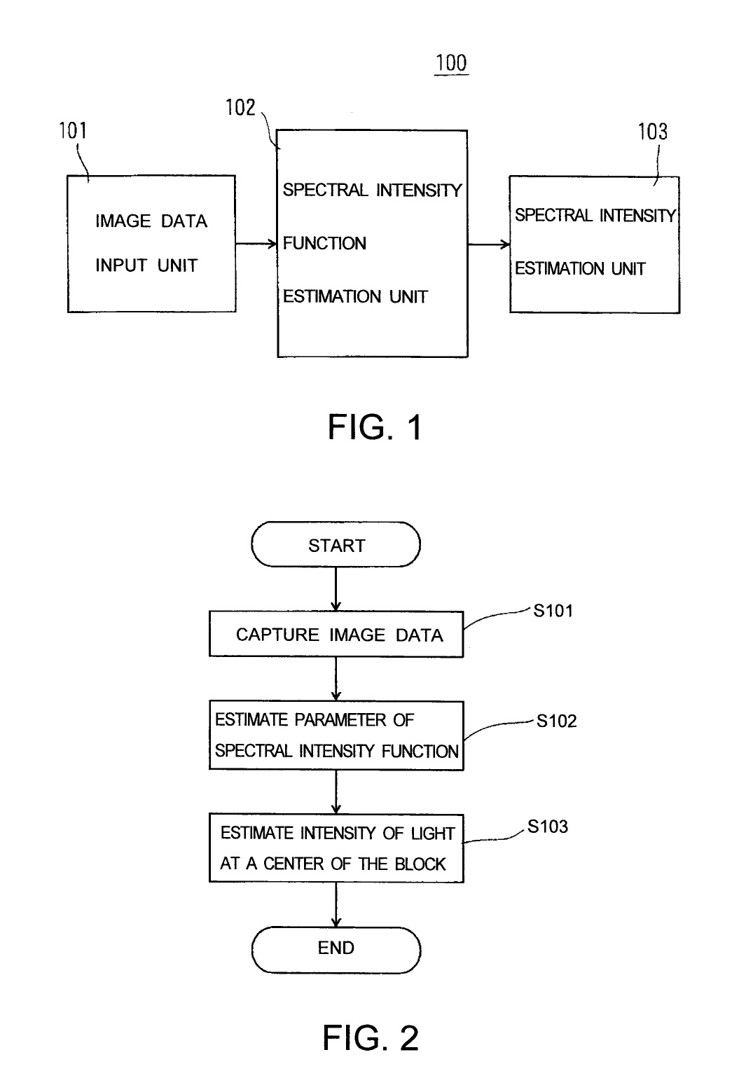

The imaging apparatus 100 of the first embodiment is explained by referring to FIGS. 1˜3.

### (1) COMPONENT OF THE IMAGING APPARATUS 100

FIG. 1 is a block diagram of the imaging apparatus 100 of the first embodiment. The imaging apparatus 100 includes an image data input unit 101, a spectral intensity function estimation unit 102, and a spectral intensity estimation unit 103. The image data input unit 101 captures input data (measured signal values) from each photo detector in a block. The spectral intensity function estimation unit 102 estimates parameters of the spectral intensity function (defining an intensity of a light incident to each photo detector) from the image data. The spectral intensity estimation unit 103 estimates the intensity of the light incident to each photo detector from the spectral intensity function with the parameter.

### (2) OPERATION OF THE IMAGING APPARATUS 100

Operation of the imaging apparatus 100 is explained by referring to FIGS. 1 and 2, the spectral weight, the spectral intensity function, and the model error. FIG. 2 is a flow chart of processing of the imaging apparatus 100.

First, the image data input unit 101 captures image data having a spectral intensity of each photo detector in a block and a measured signal value of each photo detector (S101).

Next, the spectral intensity function estimation unit 102 estimates parameters of the spectral intensity function defining a light intensity in the block (S102). An expression of the spectral intensity function, the spectral weight and an expression of the model error E, are previously stored in the spectral intensity function estimation unit 102.

The spectral intensity estimation unit 103 calculates an intensity of light at a center of the block ((x,y)=(0,0)) using the spectral intensity function with the parameter (S103). As mentioned-above, the spectral intensity function is already obtained. Accordingly, by substituting “(x,y)=(0,0)” for the spectral intensity function, the intensity of light at the center of the block is calculated. For example, in the equation (1), output value is “βₐ, β_{b}, β_{c}, β_{d}”.

### (3) EFFECT

In this way, in the imaging apparatus 100, a parameter of the spectral intensity function (as a model of light intensity in the block) is estimated from the measured signal value. Accordingly, the intensity of light (having a plurality of different spectra) can be estimated for each spectrum.

### (4) MODIFICATION EXAMPLES

Next, modification examples of the first embodiment are explained.

### (4-1) First Modification Example

The first modification example is explained. By rewriting the spectral weight in the equation (2) based on a spectral transmission of color filter, the image sensor having color filters except for WRGB filters can be applied. In this case, the number of colors to output should not be larger than a rank of matrix C_{cf} of the equation (2). This condition represents that the number of kinds of color filters is an upper limit of the number of colors to output.

### (4-2) Second Modification Example

Next, the second modification example is explained. An array of photo detectors except for a square grid, i.e., a block shape except for a square, can be applied. For example, with regard to the image sensor of a pixel-interleaved array (photo detectors are alternatively arranged) shown in FIG. 5 or a hexagonal grid, a square block having a photo detector at the center (shown in FIG. 3) is not extracted.

In order to capture an output image (photo detectors are arranged in square grid) from the image sensor of the pixel-interleaved array or the hexagonal grid, an intensity of light of a gap between photo detectors (shown in a point 501 in FIG. 5) should be calculated. In a method for estimating parameter of the spectral intensity function of the first embodiment, the array of photo detectors may not be a square grid.

### (4-3) Third Modification Example

Next, the third modification example is explained. In FIG. 3, by changing the origin of X-axis and Y-axis, an intensity of light at arbitrary position in the block can be calculated.

### (4-4) Fourth Modification Example

Next, the fourth modification example is explained. The spectral intensity function may be an expression except for the second term polynomial expression such as the equation (1). First, the number of terms of polynomial expression is easily increased. If the number of terms increases, the spectral intensity function represents a more complicated pattern, and the image captured by the imaging apparatus is expected to be fine. On the other hand, if the number of terms becomes too large, the parameters of the spectral intensity function becomes more sensitive to noise, and the image obtained from the imaging apparatus 100 becomes noisy.

Furthermore, a function except for a polynomial expression can be used as a basis function. The spectral intensity function (equation (1)) having the polynomial expression as the basis function coincides with an expression of Maclaurin's expansion of the function.

In the same way, by setting the basis function to a trigonometrical function, the spectral intensity function may be an expression of a Fourier series expansion. Alternatively, all functions as a base of wavelet may be used as the basis function of the spectral intensity function.

### (4-5) Fifth Modification Example

Next, the fifth modification example is explained. In the spectral intensity function of the equation (1), all terms except for absolute terms are common, i.e., the same value. However, if a condition that the spectral intensity function is represented as a weighted sum of the basis function (function of position coordinate) and the parameter is satisfied, the spectral intensity function may be another expression.

For example, if it is previously known that a behavior of blue color (B) does not correlate with another color, parameter of fₐ(x,y) may be differently set. However, as mentioned-above, the number of parameters is not larger than the number of photo detectors in the block.

### (4-6) Sixth Modification Example

Next, the sixth modification example is explained. Definition of the model error E is not necessary to be the equation (5). For example, by using a positive real number G and a position weight K(x,y), the model error E may be calculated as follows.

$$\begin{matrix}K ( x , y ) = exp ( - \frac{1}{G} ( x , y ) ( \begin{matrix}1 & 0 \\ 0 & 1\end{matrix} ) ( \begin{matrix}x \\ y\end{matrix} ) ) & ( 8 ) \\ E = {\sum }_{i = 0}^{24} {( K ( {x}_{i} , {y}_{i} ) ( s [ {x}_{i} , {y}_{i} ] - {I}^{′} [ {x}_{i} , {y}_{i} ] ) )}^{2} & ( 9 )\end{matrix}$$

The value G should be adjusted by a user. The larger the value of G is, the more the output image is blurred. On the other hand, the smaller the value of G is, the lower the estimation accuracy of the parameter of the spectral intensity function is.

The spectral intensity function is defined as an expression based on Maclaurin's expansion such as the equation (1). In the case of approximation of function based on Maclaurin's expansion, farer the distance from point (x,y)=(0,0), worse the accuracy of approximation becomes. So, it is natural that a difference between the measured signal value and model signal value at the point near (0,0) is smaller than the difference of farer point. Accordingly, it is effective to improve the accuracy of parameter estimation that an error effect at a photo detector position apart from the center of the block make small.

The equation (9) is transformed as follows.

E=|KS−KW β|² (10)

In the equation (9), “K” is a diagonal matrix represented as follows.

$$K = ( \begin{matrix}K ( {x}_{0} , {y}_{0} ) & 0 & 0 & 0 & 0 & 0 & 0 \\ 0 & K ( {x}_{1} , {y}_{1} ) & 0 & 0 & 0 & 0 & 0 \\ 0 & 0 & ⋰ & 0 & 0 & 0 & 0 \\ 0 & 0 & 0 & K ( {x}_{5} , {y}_{5} ) & 0 & 0 & 0 \\ 0 & 0 & 0 & 0 & K ( {x}_{6} , {y}_{6} ) & 0 & 0 \\ 0 & 0 & 0 & 0 & 0 & ⋰ & 0 \\ 0 & 0 & 0 & 0 & 0 & 0 & K ( {x}_{24} , {y}_{24} )\end{matrix} ) \qquad ( 11 )$$

The parameter of the spectral to minimize the model error of the equation (9) is calculated by the steepest-descent method or the conjugated gradient method.

In the same way as the equation (7), the vector β is represented as follows.

β=(KW)⁺KS (12)

### The Second Embodiment

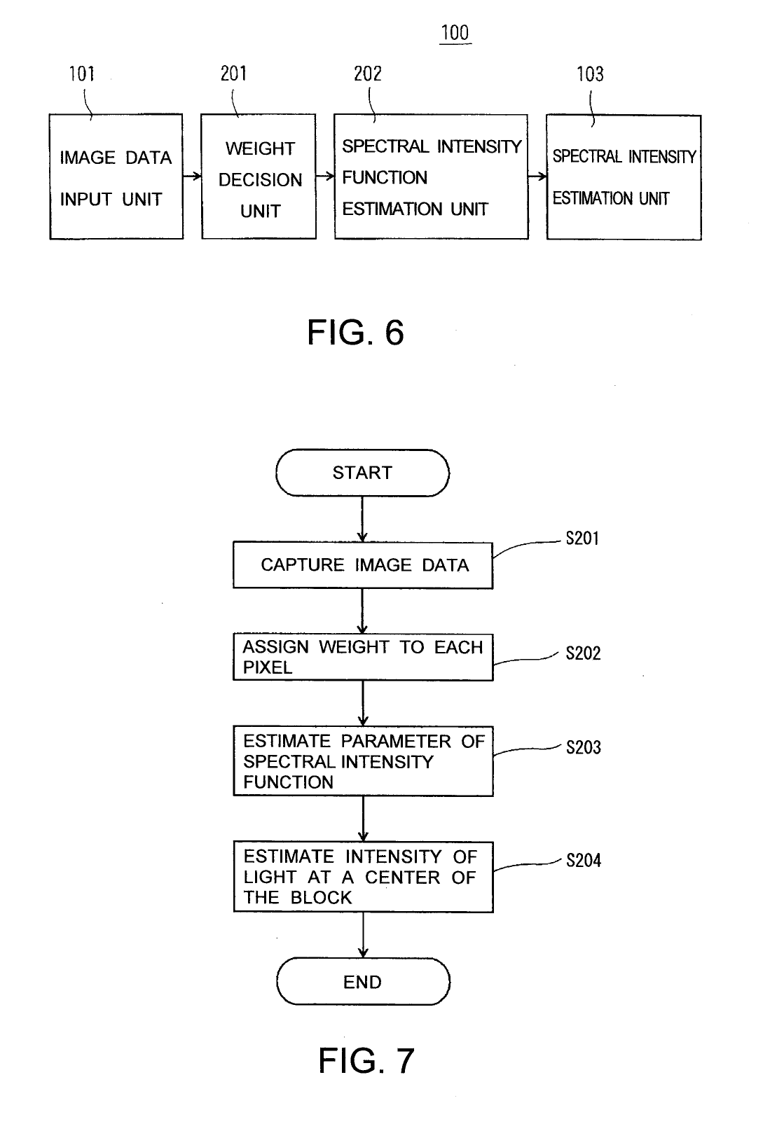

The second embodiment of the present invention is explained by referring to FIGS. 6˜10.

### (1) PURPOSE OF THE SECOND EMBODIMENT

If the first embodiment is applied to an edge part (each intensity of light having different spectral does not correlate each other in a block), an output different from the original intensity of light may be obtained. A parameter of the spectral intensity function may be calculated using a measured signal value not correlative with a light intensity of the edge part (center of the block).

In order to solve this problem, when an intensity of an edge is large, influence (on the model error) of a photo detector distant from the edge-in the block may be reduced. The second embodiment realizes this function.

### (2) COMPONENT OF THE IMAGING APPARATUS 100

FIG. 6 is a block diagram of the imaging apparatus 100 of the second embodiment. The imaging 100 includes an image data input unit 101, a weight decision unit 201, a spectral intensity function estimation unit 202, and a spectral intensity estimation unit 103. The image data input unit 101 captures input data (measured signal values) from each photo detector in a block. The weight decision unit 201 calculates a weight of each photo detector of the image sensor by using a direction and an intensity of an edge. The spectral intensity function estimation unit 202 estimates parameters of the spectral intensity function (defining an intensity of a light incident to each photo detector) from the image data. The spectral intensity estimation unit 103 estimates the intensity of the light incident to each photo detector from the spectral intensity function with the parameter.

### (3) OPERATION OF THE IMAGING APPARATUS 100

Operation of the imaging apparatus 100 is explained by referring to FIGS. 6˜9. FIG. 7 is a flow chart of processing of the imaging apparatus 100 according to the second embodiment. In following explanation, a block shown in FIG. 3 is used as an example.

First, the image data input unit 101 captures image data comprising a spectral sensitivity and a measured signal value of each photo detector in a block (S201). Next, the weight decision unit 201 calculates a positional weight (positive real number) of each photo detector in the block, based on the measured signal value acquired from each photo detector. A method for calculating the positional weight is explained.

First, three photo detectors having the same spectral sensitivity (same color) and not positioned at the same straight line are selected from the block. The three photo detectors are called “pᵢ(xᵢ,yᵢ), pⱼ(xⱼ,yⱼ), pₖ(xₖ,yₖ)”, and the respective signal values are “Sᵢ, Sⱼ, Sₖ”. As shown in FIG. 9, in three-dimensional space having x-axis, y-axis (each representing a position on the image sensor), and s-axis (representing a measured signal value), three points pᵢ, pⱼ, and pₖ respectively correspond to 902, 903, and 904. As shown in a triangle 901 surrounded by the three points pᵢ (902), pⱼ (903), and pₖ (903), a light intensity plainly changes. A gradient of the triangle 901 (dₓ along x-axis direction and d_{y} along y-axis direction) is represented as follows.

$${d}_{x} = \frac{( {s}_{j} - {s}_{i} ) {y}_{k} + ( {s}_{i} - {s}_{k} ) {y}_{j} + ( {s}_{k} - {s}_{j} ) {y}_{i}}{( {x}_{j} - {x}_{i} ) {y}_{k} + ( {x}_{i} - {x}_{k} ) {y}_{j} + ( {x}_{k} - {x}_{j} ) {y}_{i}} \\ {d}_{y} = \frac{( {s}_{j} - {s}_{i} ) {x}_{k} + ( {s}_{i} - {s}_{k} ) {x}_{j} + ( {s}_{k} - {s}_{j} ) {x}_{i}}{( {y}_{j} - {y}_{i} ) {x}_{k} + ( {y}_{i} - {y}_{k} ) {x}_{j} + ( {y}_{k} - {y}_{j} ) {x}_{i}} \qquad ( 13 )$$

Assume that the number of kinds of spectral sensitivity (the number of kinds of colors) of photo detectors in a block is L, and the number of triangles formed by three photo detectors each having m-th spectral sensitivity in L is n[m] (m=0, . . . ,L−1). Furthermore, with regard to q-th triangle (q=0, . . . ,n[m]−1) formed by the three photo detectors each having m-th spectral sensitivity, a gradient of the q-th triangle (dₓ along x-axis direction and d_{y} along y-axis direction) is represented as dₓ[m,q] and d_{y}[m,q].

For example, in FIG. 3, photo detectors having four kinds of spectral sensitivity (R,G,B,W) exist in the block. Among these photo detectors, 0-th spectral sensitivity (color) is Blue, and 0-th triangle formed by photo detectors each having 0-th spectral sensitivity is a triangle formed by three photo detectors 1300, 1301, and 1302. In this case, dₓ[0,0] and d_{y}[0,0] are calculated by substituting “(xᵢ,yᵢ,sᵢ)=(−2,−2,s₀), (xⱼ,yⱼ,sⱼ)=(0,−2,s₂), (xₖ,yₖ,sₖ)=(0,−2,s₁₀)” for the equation (13).

The weight K of the photo detector is calculated as follows.

$$K ( x , y ) = exp ( - \frac{1}{G} ( x , y ) C ( \begin{matrix}x \\ y\end{matrix} ) ) \\ C = {\sum }_{m = 0}^{l - 1} \{ {\sum }_{q = 0}^{n [ m ] - 1} ( \begin{matrix}{{d}_{x} [ m , q ]}^{2} & {d}_{x} [ m , q ] {d}_{y} [ m , q ] \\ {d}_{x} [ m , q ] {d}_{y} [ m , q ] & {{d}_{y} [ m , q ]}^{2}\end{matrix} ) \} \qquad ( 14 )$$

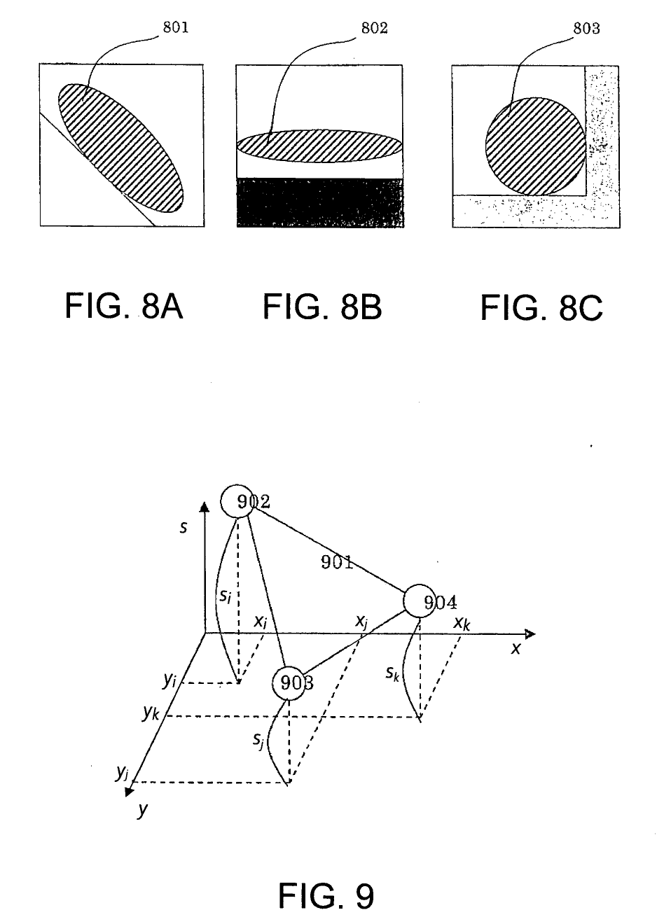

As shown in an ellipse 801 of FIG. 8A, a counter line of the weight K is the ellipse having a major axis extended along the edge. When a direction of the edge changes, a direction of the major axis changes as shown in an ellipse 802 of FIG. 8B, and lengths of the major axis and the minor axis respectively change. Furthermore, at a corner of the edge as shown in an ellipse 803 of FIG. 8C, lengths of the major axis and the minor axis respectively shorten. The larger the intensity of edge is, the shorter the major axis and the minor axis are. Furthermore, the smaller the weight of the photo detector is, the longer a distance between the detector and a center of the block is.

Next, the spectral intensity function estimation unit 202 estimates a parameter of the spectral intensity function (S203). Definitions of the spectral intensity function and the spectral weight are the same as in the first embodiment, and the model error is represented as the equation (9).

Last, the spectral intensity estimation unit 103 calculates a light intensity for each spectral at a center of the block ((x,y)=(0,0)) by using the spectral intensity function with the parameter (obtained by the spectral intensity function estimation unit 202) (S204).

### (4) MODIFICATION EXAMPLES

Modification examples of the second embodiment are explained.

### (4-1) First Modification Example

In the same way as in the first embodiment, the second embodiment may be applied irrespective of a size and a shape of the block.

### (4-2) Second Modification Example

In the same way as in the first embodiment, in the second embodiment, an expression of the spectral intensity expression is not limited to a polynomial expression of x and y.

### (4-3) Third Modification Example

In the same way as in the first embodiment, in the second embodiment, the weight function may be any expression if the weight is a positive real number.

### (4-4) Fourth Modification Example

In the same way as in the first embodiment, in the second embodiment, dₓ and d_{y} are not always represented by the equation (3). A quantity having positive correlation with a positional change of the light intensity in a block is used.

### (4-5) Fifth Modification Example

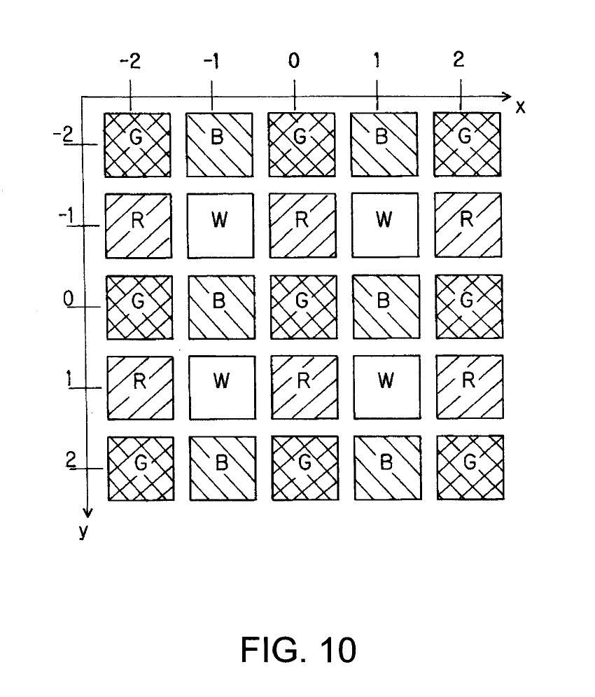

The positional weight K changes by a pattern of the number of color filters in a block. Accordingly, the positional weight K may be corrected by the pattern. For example, with regard to a location pattern of color filters in a 5×5 pixels block, both cases of FIGS. 3 and 10 are explained.

First, each element of a matrix C in the equation (14) corresponds a square sum of difference between measured signal values from two photo detectors having the same color filter.

Next, in comparison with R·G·B photo detectors, W photo detector has a higher sensitivity for all wavelengths, the measured signal value from the W photo detector is larger, and a difference between measured signal values from two W photo detectors is larger. As a result, dₓ and d_{y} calculated for the W photo detector are larger than for R·G·B photo detectors.

The number of W photo detectors is six in FIG. 3 and four in FIG. 10. With regard to a matrix C in the equation (14), each element calculated from a pattern of FIG. 10 is larger than each element calculated from a pattern of FIG. 3. Accordingly, even if an image of the same texture is captured, the weight assigned to each photo detector largely changes whenever the block is shifted on the image. As a result, periodical noise will be observed at a texture part on a line.

In order to solve this problem, a weight w[m] to normalize the number of the color filters for each color in the block is used as follows.

$$K ( x , y ) = exp ( - \frac{1}{G} ( x , y ) \{ {\sum }_{m = 0}^{l - 1} \{ w [ m ] {\sum }_{q = 0}^{n [ m ] - 1} ( \begin{matrix}{{d}_{x} [ m , q ]}^{2} & {d}_{x} [ m , q ] {d}_{y} [ m , q ] \\ {d}_{x} [ m , q ] {d}_{y} [ m , q ] & {{d}_{y} [ m , q ]}^{2}\end{matrix} ) \} \} ( \begin{matrix}x \\ y\end{matrix} ) ) \qquad ( 15 )$$

In the equation (15), “w[m]” represents a value that a ratio of the number of color filters for each color in a block is respectively divided with the number of the color filter.

For example, in FIG. 3, a ratio (W:R:G:B) of the number of color filters is “1:1:1:1”. The number of color filters of each color is, six for W and G, four for R, and nine for B. Assume that w[0] is W, w[1] is R, w[2] is G, and w[3] is B. In this case, w[0]=1/6, w[1]=1/4, w[2]=1/6, and w[3]=1/9.

Furthermore, in case of Bayer array that W photo detector is changed to G photo detector in FIG. 3, “R:G:B” is “1:2:1”. In this case, w[1]=1/4, w[2]=1/12, and w[3]=1/9. Accordingly, change of the weight based on change of ratio of the number of color filters in the block is suppressed, and the noise is also reduced.

Instead of the number of the color filters, a user can use the number of triangles n[m]. “w[m]=1/n[m]” is also useful for the normalization.

A user may control not only denominator of the weight, but also numerator of the weight. For example, a user may use w[1]=1/n[1], w[2]=1/n[2], w[3]=1/n[3] for Bayer array. The numerator is proportional to the ratio of color filter, R:G:B=1:2:1.

### The Third Embodiment

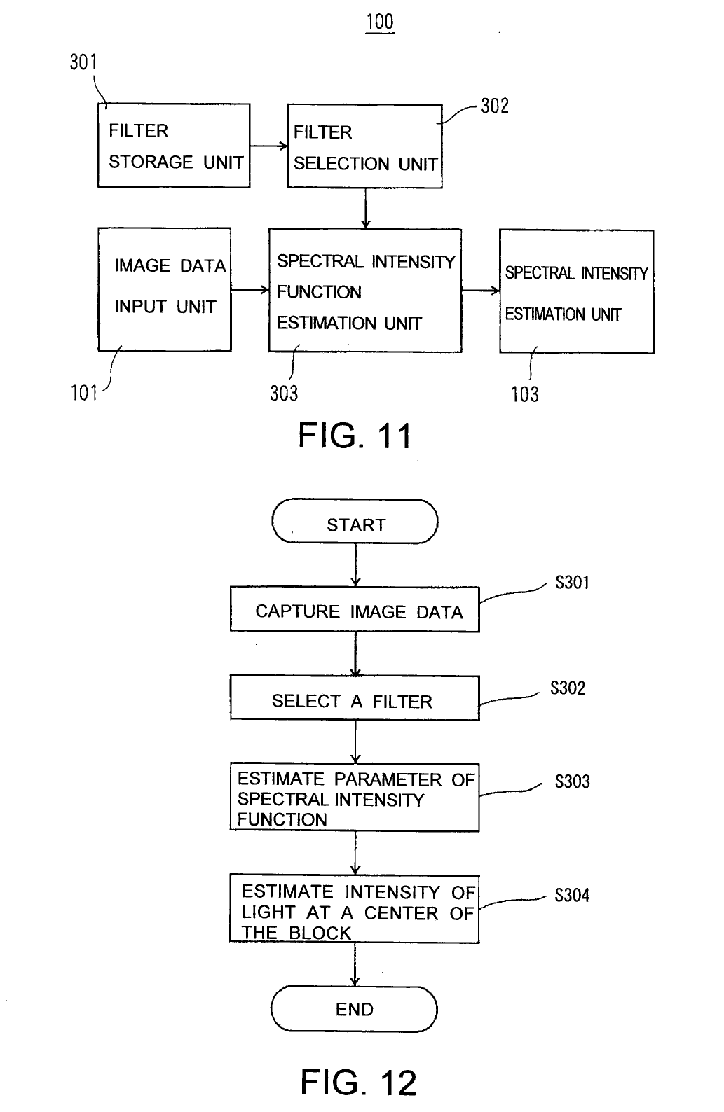

The imaging apparatus 100 of the third embodiment is explained by referring to FIGS. 11˜13.

### (1) PURPOSE OF THE THIRD EMBODIMENT

In the first embodiment, in order to calculate a parameter of the spectral intensity function, the model error should be minimized. However, the steepest-descent method, the conjugated gradient method, and the pseudo-inverse matrix (each used for minimizing the model error) require a large calculation cost.

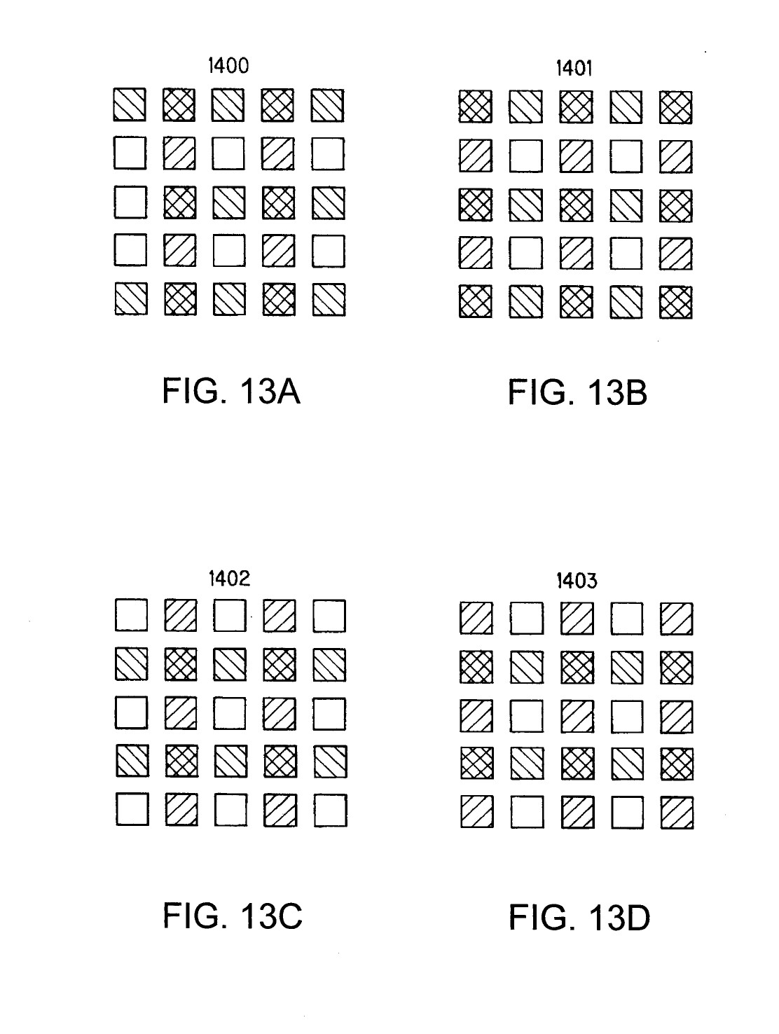

On the other hand, with regard to the color filter, the same pattern periodically appears by shifting a block on the image. In case of processing all areas of the image, with regard to W in the equation (5), a finite number of different patterns appear. For example, in a color filter array of FIG. 3, only four kinds of patterns 1400˜1403 appear as shown in FIGS. 13A˜13D. Accordingly, a pseudo-inverse matrix (filter to estimate parameter of spectral intensity function) of W corresponding to each pattern is previously calculated and stored in a memory. As a result, the processing time can be reduced. The imaging apparatus 100 of the third embodiment provides this function.

### (2) COMPONENT OF THE IMAGING APPARATUS 100

The imaging apparatus 100 includes an image data input unit 101, a filter storage unit 301, a filter selection unit 302, a spectral intensity function estimation unit 303, and a spectral intensity estimation unit 103. The image data input unit 101 captures input data (measured signal values) from each photo detector in a block. The filter storage unit 301 stores filters to estimate parameter of the spectral intensity function from image data. The filter selection unit 302 selects a suitable filter from the filter storage unit 301. The spectral intensity function estimation unit 303 estimates parameters of the spectral intensity function using a measured signal value and a filter (selected by the filter selection unit 302). The spectral intensity estimation unit 103 estimates the intensity of the light incident to each photo detector from the spectral intensity function with the parameter.

### (3) OPERATION OF THE IMAGING APPARATUS 100

Hereinafter, operation of the imaging apparatus 100 of the third embodiment is explained by referring to FIGS. 11 and 12. FIG. 12 is a flow chart of processing of the imaging apparatus 100. In the following explanation, a block shown in FIG. 3 is used as an example.

Before processing of each block, the filter storage unit 301 calculates a filter W⁺ necessary for estimating parameter β of the spectral intensity function to minimize energy of the equation (5), and stores the filter. “W” is uniquely determined by determining shape and position of the block. For example, in a color filter of FIG. 3, only four patterns of the color filter in the block exist as shown in FIGS. 13A˜13D. Accordingly, “W” is limited to the four kinds. “W+” corresponding to “W” of the four kinds is calculated and stored in the filter storage unit 301.

Hereinafter, processing is subjected to a block in an image corresponding to a photo detector face of the image sensor, and a light intensity at a center of the block is estimated for each spectral. When processing of the block is completed, a position of the block is shifted on the image, and processing of the block is repeated.

First, the image data input unit 101 captures image data comprising a spectral sensitivity and a measured signal value of each photo detector in a block (S301).

Next, the filter selection unit 302 selects a suitable filter from filters stored in the filter storage unit 301 based on a pattern of spectral sensitivity of each photo detector in the block (S302).

Next, the spectral intensity function estimation unit 303 operates convolution of the equation (7) using the filter and the measured signal value, and estimates a parameter of the spectral intensity function (S303).

The spectral intensity estimation unit 103 calculates an intensity of light at a center of the block using the spectral intensity function with the parameter (S304).

### (4) MODIFICATION EXAMPLE

Next, modification examples of the third embodiment are explained. In the third embodiment, by increasing the number of filters in the filter storage unit 301, image quality is improved.

In the first embodiment, processing can be quickly executed by aiming at a finite number of patterns of “W” in the equation (7). However, a filter cannot be adjusted based on an edge, and image quality is not improved.

On the other hand, in the second embodiment, a filter based on the edge is used, and image quality is improved. However, innumerable number of patters of filter “(KW) ⁺K” exists based on the edge, and all filters cannot be previously calculated.

Accordingly, each filter “(KW) ⁺K” corresponding to a positional weight “K” of infinite number of patterns is stored in the filter storage unit 301. By changing the filter based on the edge, image quality is improved more than in the first and third embodiments, and processing is executed quicker than in the second embodiment.

The positional weight K is represented as follows.

$$\begin{matrix}K ( x , y ) = exp ( - ( x , y ) C ( \begin{matrix}x \\ y\end{matrix} ) ) \\ = exp ( - ( x , y ) ( \begin{matrix}{C}_{xx} & {C}_{xy} \\ {C}_{xy} & {C}_{yy}\end{matrix} ) ( \begin{matrix}x \\ y\end{matrix} ) )\end{matrix} \qquad ( 16 )$$

From each element in matrix C of the equation (16), the following three parameters are obtained.

$${λ}_{+} = \frac{{C}_{xx} + {C}_{yy}}{2} \pm \sqrt{\frac{{( {C}_{xx} - {C}_{yy} )}^{2}}{4} + {C}_{xy}^{2}} \\ θ = \{ \begin{matrix}\frac{π}{4} & if ( {C}_{xx} = {C}_{yy} ) ⋂ ( {C}_{xy} ≻ 0 ) \\ - \frac{π}{4} & if ( {C}_{xx} = {C}_{yy} ) ⋂ ( {C}_{xy} ≺ 0 ) \\ undefined & {ifC}_{xx} = {C}_{yy} = {C}_{xy} = 0 \\ \frac{1}{2} {tan}^{- 1} ( \frac{2 {C}_{xy}}{{C}_{xx} - {C}_{yy}} ) & otherwise\end{matrix} \qquad ( 17 )$$

Three parameters λ₊, λ₋, θ relate with a shape of the ellipse in FIG. 8. A length of the minor axis is (1/λ₊)^{0.5}, a length of the major axis is (1/λ₋)^{0.5}, and an angle between the major axis and the minor axis is θ.

By using these parameters, the equation (16) is represented as follows.

$$K ( x , y ) = exp ( - ( x , y ) ( \begin{matrix}{λ}_{+} {cos}^{2} θ + {λ}_{-} {sin}^{2} θ & ( {λ}_{+} - {λ}_{-} ) sin θ cos θ \\ ( {λ}_{+} - {λ}_{-} ) sin θ cos θ & {λ}_{+} {sin}^{2} θ + {λ}_{-} {cos}^{2} θ\end{matrix} ) ( \begin{matrix}x \\ y\end{matrix} ) ) \qquad ( 18 )$$

By changing the three parameters λ₊, λ₋, θ at a predetermined width and calculating a corresponding weight K, a filter is generated from the weight K. In this case, filters corresponding to intensity and angle of various edges can be stored.

For example, ten kinds of λ₊ and λ₋ are prepared at a range “1/9˜1”, and four kinds of θ is prepared at a range “0˜π”. In case of storing a filter into a table, “λ₊, λ₋, θ” by which the filter is generated are stored with the filter.

In case of selecting the filter, first, a matrix C of the equation (16) is calculated from the block. Next, “λ₊, λ₋, θ” are calculated using the equation (17). Last, a filter corresponding to K calculated by “λ₊, λ₋, θ” is selected from the table.

In the disclosed embodiments, the processing can be accomplished by a computer-executable program, and this program can be realized in a computer-readable memory device.

In the embodiments, the memory device, such as a magnetic disk, a flexible disk, a hard disk, an optical disk (CD-ROM, CD-R, DVD, and so on), an optical magnetic disk (MD and so on) can be used to store instructions for causing a processor or a computer to perform the processes described above.

Furthermore, based on an indication of the program installed from the memory device to the computer, OS (operation system) operating on the computer, or MW (middle ware software), such as database management software or network, may execute one part of each processing to realize the embodiments.

Furthermore, the memory device is not limited to a device independent from the computer. By downloading a program transmitted through a LAN or the Internet, a memory device in which the program is stored is included. Furthermore, the memory device is not limited to one. In the case that the processing of the embodiments is executed by a plurality of memory devices, a plurality of memory devices may be included in the memory device. The component of the device may be arbitrarily composed.

A computer may execute each processing stage of the embodiments according to the program stored in the memory device. The computer may be one apparatus such as a personal computer or a system in which a plurality of processing apparatuses are connected through a network. Furthermore, the computer is not limited to a personal computer. Those skilled in the art will appreciate that a computer includes a processing unit in an information processor, a microcomputer, and so on. In short, the equipment and the apparatus that can execute the functions in embodiments using the program are generally called the computer.

Other embodiments of the invention will be apparent to those skilled in the art from consideration of the specification and practice of the invention disclosed herein. It is intended that the specification and examples be considered as exemplary only, with the true scope and spirit of the invention being indicated by the following claims.

What is claimed is:

1. An apparatus for capturing an image, comprising:
an image sensor having a plurality of photo detectors, each photo detector having a spectral sensitivity;
an image data input unit configured to input image data having a position, a spectral sensitivity, and a measured signal value of each photo detector in an area of the image sensor;
a parameter estimation unit configured to estimate each parameter of a plurality of spectral intensity functions using the image data, each spectral intensity function representing an intensity of light corresponding to a spectrum in the area;
a spectral intensity estimation unit configured to estimate the intensity of light in the area using the plurality of spectral intensity functions with each parameter; and
an output unit configured to output the intensity of light for each photo detector.

2. The apparatus according to claim 1,
wherein the parameter estimation unit comprises
a first storage unit configured to store the plurality of spectral intensity functions;
a second storage unit configured to store a spectral weight of each spectral intensity function for each photo detector, the spectral weight being a larger value when the spectral transmission corresponding to the spectral intensity function is more similar to the spectral sensitivity of the photo detector; and
a calculation unit configured to calculate the parameter so that a model error as an absolute value of difference between a model signal value and the measured signal value is minimized, the model signal value being a weighted sum of each spectral intensity function with the spectral weight.

3. The apparatus according to claim 2,
wherein the calculation unit calculates the model error as a square sum of difference between the measured signal value and the model signal value.

4. The apparatus according to claim 2,
wherein the calculation unit multiplies a positional weight of each photo detector by a square sum of a difference between the measured signal value and the model signal value, and calculates the model error as the sum of the product of each photo detector, the positional weight being a smaller value when a position of the photo detector is more distant from the center of the area.

5. The apparatus according to claim 2,
wherein the calculation unit multiplies a positional weight of each photo detector by a square sum of a difference between the measured signal value and the model signal value, and calculates the model error as the sum of the product of each photo detector, the positional weight being a smaller value when a position of the photo detector is more distant from an edge part in the image of the area.

6. The apparatus according to claim 2,
wherein derived functions of at least two or all the plurality of spectral intensity functions are identical.

7. The apparatus according to claim 2,
wherein the spectral intensity function is a weighted sum of the parameter and each basis function representing a position in the area.

8. The apparatus according to claim 7,
wherein the parameters corresponding to the same basis function in at least two or all of the plurality of spectral intensity functions are identical.

9. The apparatus according to claim 7,
wherein the basis function is a polynomial expression using two-dimensional coordinate representing the position in the area.

10. The apparatus according to claim 9,
wherein order of the polynomial expression is equal to or below five.

11. The apparatus according to claim 6,
wherein the basis function is a trigonometrical function using a two-dimensional coordinate representing the position in the area.

12. The apparatus according to claim 1,
wherein the spectral intensity estimation unit outputs a value of each spectral intensity function at each position on the image.

13. A method for capturing an image by an image sensor having a plurality of photo detectors, each photo detector having a spectral sensitivity, comprising:
inputting image data having a position, a spectral sensitivity, and a measured signal value of each photo detector in an area of the image sensor;
estimating each parameter of a plurality of spectral intensity functions using the image data, each spectral intensity function representing an intensity of light corresponding to a spectrum in the area;
estimating the intensity of light in the area using the plurality of spectral intensity functions with each parameter; and
outputting the intensity of light for each photo detector.

14. A computer readable medium storing program codes for causing a computer to capture an image by an image sensor having a plurality of photo detectors, each photo detector having a spectral sensitivity, the program codes comprising:
a first program code to input image data having a position, a spectral sensitivity, and a measured signal value of each photo detector in an area of the image sensor;
a second program code to estimate each parameter of a plurality of spectral intensity functions using the image data, each spectral intensity function representing an intensity of light corresponding to a spectrum in the area;
a third program code to estimate the intensity of light in the area using the plurality of spectral intensity functions with each parameter; and
a fourth program code to output the intensity of light for each photo detector.
